(19) United States
(12) Patent Application Publication
(10) Pub. No.: US 2014/0050909 A1
(43) Pub. Date: Feb. 20, 2014

(54) LAMINATE FOR WINDOW SHEET, WINDOW SHEET COMPRISING THE SAME, AND DISPLAY APPARATUS COMPRISING THE SAME

(71) Applicants: Jin Hee CHOI, Uiwang-si (KR); Do Young KIM, Uiwang-si (KR); Kyoung Ku KANG, Uiwang-si (KR)

(72) Inventors: Jin Hee CHOI, Uiwang-si (KR); Do Young KIM, Uiwang-si (KR); Kyoung Ku KANG, Uiwang-si (KR)

(21) Appl. No.: 14/059,634

(22) Filed: Oct. 22, 2013

Related U.S. Application Data
(63) Continuation of application No. PCT/KR2013/000610, filed on Jan. 25, 2013.

(30) Foreign Application Priority Data
Jan. 27, 2012 (KR) 10-2012-0008575
Apr. 19, 2012 (KR) 10-2012-0040962

(51) Int. Cl. B32B 27/08

(52) U.S. Cl. CPC B32B 27/08
USPC 428/217; 428/447; 428/412; 428/313.9

(57) ABSTRACT

A laminate includes a base film, and a silsesquioxane-containing film formed on at least one of upper and lower sides of the base film. Also disclosed are a window sheet including the laminate, and a display apparatus including the window sheet.

### CROSS-REFERENCE TO RELATED APPLICATIONS

This application claims priority under 35 U.S.C. §119 to Korean Patent Application No. 10-2012-0008575, filed on Jan. 27, 2012, and Korean Patent Application No. 10-2012-0040962, filed on Apr. 19, 2012, in the Korean Intellectual Property Office, entitled: “Laminate For Window Sheet, Window Sheet Comprising the Same, and Display Apparatus Comprising the Same,” which are each incorporated by reference herein in its entirety.

This application is a continuation of pending International Application No. PCT/KR2013/000610, entitled “Laminate For Window Sheet, Window Sheet Comprising the Same, and Display Apparatus Comprising the Same,” which was filed on Jan. 25, 2013, the entire contents of which are hereby incorporated by reference.

### BACKGROUND

1. Field

Embodiments relate to a laminate for a window sheet, a window sheet including the same, and a display apparatus including the same.

2. Description of Related Art

Glass is generally used for electrode substrates of conventional liquid crystal display panels, or for display materials for plasma display panels, electroluminescent display tubes, or light emitting diodes. However, since glass is vulnerable to impact and has a high specific gravity, production of thin and light glass is limited.

### SUMMARY

Embodiments are directed to a laminate for a window sheet, including a base film, and a film formed on at least one of upper and lower sides of the base film and containing silsesquioxane.

The laminate may have a curling height of less than about 5 mm.

The laminate may have a pencil hardness of about 6 H or more.

The base film may have a falling dart impact strength of about 5 J or more according to ASTM D4226.

The base film may have an impact resistance of about 35 cm or more as measured using a DuPont drop tester (500 g, pin ½″, specimen size of 100×100 mm).

The base film may be formed of polystyrene, (meth)acrylate-styrene copolymers, polymethylmethacrylate-rubber mixtures, acrylonitrile-styrene copolymers, polycarbonate, polyvinyl alcohol, polyethylene terephthalate, polyethylene naphthalate, polybutylene phthalate, polypropylene, polyethylene, cycloolefin polymers, cycloolefin copolymers, acryl, polyvinyl fluoride, polyamide, polyacrylate, cellophane, polyethersulfone, norbornene resins, cyclic olefin copolymers, or a mixture thereof.

The base film may have a thickness of about 50 μm to about 1000 μm.

The silsesquioxane-containing film may have a pencil hardness of about 9 H to about 10 H as determined by a pencil hardness tester (Shinto Scientific, Heidon) using a Mitsubishi pencil (UNI) after drawing a line at a speed of 0.8 mm/sec under a load of 1 kg.

The silsesquioxane-containing film may have a transmittance of about 88% or more.

The silsesquioxane-containing film may have a thickness of about 50 μm to about 500 μm.

The silsesquioxane-containing film may include a cured product of a composition containing a silsesquioxane resin.

The laminate may further include an adhesive layer between the base film and the silsesquioxane-containing film.

The adhesive layer may have a glass transition temperature of about −50° C. to about −10° C.

The adhesive layer may have a modulus (G′) of about 1×10⁴ to about 1.5×10⁶ dyn/cm².

The adhesive layer may be formed of an adhesive composition including a (meth)acrylic copolymer and a curing agent.

The (meth)acrylic copolymer may be a copolymer of a mixture of one or more monomers selected from the group of a hydroxyl group-containing vinyl monomer, an alkyl group-containing vinyl monomer, a carboxylic acid group-containing vinyl monomer, and an aromatic group-containing vinyl monomer.

The curing agent may be present in an amount of about 0.01 to 5 parts by weight based on 100 parts by weight of the (meth)acrylic copolymer.

The adhesive layer may have a thickness of about 5 μm to about 50 μm.

The laminate may further include a coating layer formed on one side of the silsesquioxane-containing film.

The coating layer may have a water contact angle of about 80° or more or a hexadecane contact angle of about 25° or more at 25° C.

The coating layer may have a reflectivity of about 2% or less at a wavelength of 550 nm.

The coating layer may be formed of a composition including a (meth)acrylate-based compound and inorganic nanoparticles.

The (meth)acrylate-based compound may include a fluorine-containing (meth)acrylate-based compound.

The fluorine-containing (meth)acrylate-based compound may include a fluorine-modified (meth)acrylate copolymer, a fluorine-modified (meth)acrylate monomer, or a mixture thereof.

A weight ratio of the fluorine-modified (meth)acrylate monomer to the fluorine-modified (meth)acrylate copolymer in the composition may range from about 0.1 to about 6.

The composition may further include an initiator.

The composition may include about 40 to 95 parts by weight of the (meth)acrylate-based compound, about 1 to 50 parts by weight of the inorganic nanoparticles, and about 0.1 to 10 parts by weight of the initiator, based on 100 parts by weight of the composition.

The (meth)acrylate-based compound may include one or more of a (meth)acrylic UV curable resin or a polyfunctional (meth)acrylate monomer.

The composition may further include one or more of a silicon-modified polyacrylate or an anti-foaming agent.

The composition may further include an initiator.

The composition may include about 30 to 70 parts by weight of the UV curable resin, about 5 to 25 parts by weight of the polyfunctional (meth)acrylate monomer, about 5 to 45 parts by weight of the inorganic nanoparticles, and, based on a total of 100 parts by weight of the UV curable resin, the polyfunctional (meth)acrylate monomer, and the inorganic nanoparticles, about 0.1 to 10 parts by weight of the initiator, about 0.1 to 5 parts by weight of the silicon-modified polyacrylate, and about 0.01 to 5 parts by weight of the anti-foaming agent.

The inorganic nanoparticles may include one or more of hollow silica or reactive silica.

The hollow silica may have an average particle size of about 5 nm to about 300 nm and a specific surface area of about 50 m²/g to about 1500 m²/g.

The reactive silica may have an average particle size of about 5 nm to about 300 nm.

The hollow silica may be subjected to surface treatment with a fluorine compound.

The reactive silica may be subjected to surface treatment with a (meth)acrylate-based compound.

The inorganic nanoparticles may be present in an amount of about 1 to 50 parts by weight based on a total of 100 parts by weight of the fluorine-containing (meth)acrylate-based compound and the inorganic nanoparticles.

The silicon-modified polyacrylate may include a hydroxyl group at a terminal thereof.

The silicon-modified polyacrylate may have an acid value of about 20 to 40 mgKOH/g in terms of solid content.

The anti-foaming agent may include one or more of dimethylpolysiloxane or fluorine-modified polysiloxane.

The coating layer may have a thickness of about 10 nm to about 500 nm.

The laminate may further include a hard coating layer.

Embodiments are also directed to a window sheet that includes the laminate according to an embodiment.

Embodiments are also directed to a display apparatus that includes the laminate according to an embodiment.

### BRIEF DESCRIPTION OF DRAWINGS

Features will become apparent to those of skill in the art by describing in detail example embodiments with reference to the attached drawings in which:

FIG. 1 illustrates a sectional view of a laminate in accordance with an example embodiment.

FIG. 2 illustrates a sectional view of a laminate in accordance with an example embodiment.

FIG. 3 illustrates a sectional view of a laminate in accordance with an example embodiment.

FIG. 4 illustrates a sectional view of a laminate in accordance with an example embodiment.

FIG. 5 illustrates a sectional view of a display apparatus in accordance with an example embodiment.

FIG. 6 illustrates a conceptual diagram illustrating measurement of a curling height.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

As used herein, terms such as “upper side” and “lower side” are defined with reference to the accompanying drawings. Thus, it will be understood that the term “upper side” may be used interchangeably with the term “lower side.”

In accordance with an example embodiment, a laminate may include a base film, and a film formed on at least one of upper and lower sides of the base film and containing silsesquioxane.

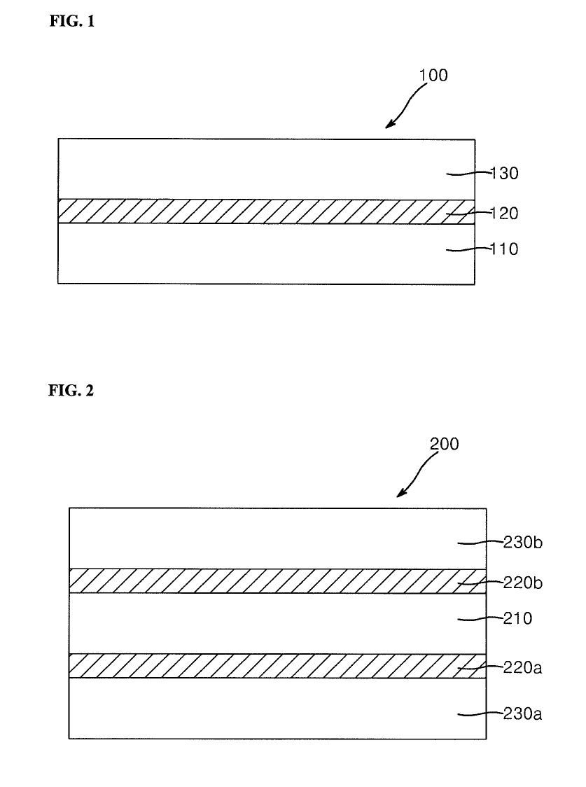

FIGS. 1 and 2 illustrate sectional views of laminates in accordance with example embodiments.

Referring to FIG. 1, a laminate 100 may include a base film 110, and a first film 130 formed on an upper side of the base film 110 and containing silsesquioxane. In FIG. 1, the laminate may include or omit an adhesive layer 120.

Referring to FIG. 2, a laminate 200 may include a base film 210, a first film 230b formed on an upper side of the base film 210 and containing silsesquioxane, and a second film 230a formed on a lower side of the base film 210 and containing silsesquioxane. In FIG. 2, adhesive layers 220a, 220b may be included in or omitted from the laminate 200.

Base Film

The base film supports the laminate and may be a silsesquioxane-free film.

The base film may have an impact resistance of about 5 J or more evaluated according to falling-dart impact strength using a DuPont brand drop tester. Within this range of the impact resistance, the base film may provide sufficient impact resistance in a lamination of a silsesquioxane-containing film, and may provide high hardness and impact resistance. For example, the base film may have a falling dart impact strength of about 5 J to about 20 J.

In measurement of the falling dart impact strength using a DuPont brand drop tester (500 g, pin ½″, specimen: 100 mm×100 mm), the base film may have an impact resistance of about 35 cm or more, e.g., about 35 cm to about 90 cm.

The impact resistance may be measured according to a steel ball drop using a DuPont brand drop tester. For example, the impact resistance of the base film may be measured using a DuPont brand drop impact tester according to ASTM D 4226. In the measurement of impact resistance, a specimen having a size of 30 mm×70 mm×base film thickness (length×width×thickness) may be used under a load of 500 g.

The base film may have a transmittance of about 90% or more, e.g., about 90% to 99%, at wavelengths of 400 to 800 nm. Within this range of transmittance, the base film may be suitable for a window sheet.

The base film may have a thickness of about 50 μm to about 1000 μm, e.g., about 100 μm to about 1000 μm, or about 100 μm to about 900 μm, or about 150 μm to about 800 μm. Within this thickness range of the base film, the laminate may be manufactured through a roll-to-roll process and may have suitable thickness and impact resistance.

In some example embodiments, the base film may be a transparent plastic film having a glass transition temperature (Tg) of about 70° C. to about 220° C.

In other example embodiments, the base film may be a transparent plastic sheet.

In some example embodiments, the base film may be formed of polystyrene, (meth)acrylate-styrene copolymers, polymethyl methacrylate-rubber mixtures, acrylonitrile-styrene copolymers, polycarbonate, polyvinyl alcohol, polyethylene terephthalate, polyethylene naphthalate, polybutylene phthalate, polypropylene, polyethylene, cycloolefin polymers, cycloolefin copolymers, acryl, polyvinyl fluoride, polyamide, polyarylate, cellophane, polyether sulfone, norbornene resins, cyclic olefin copolymers, or a mixture thereof.

For example, the base film may be formed of polycarbonate, a polymethyl methacrylate-rubber copolymer, or polyethylene terephthalate.

Silsesquioxane-Containing Film

The silsesquioxane-containing film may be a high hardness plastic film.

In an example embodiment, the silsesquioxane-containing film may have a pencil hardness of about 9 H to about 10 H, as determined by a pencil hardness tester (Shinto Scientific, Heidon) after drawing a line using a Mitsubishi pencil (UNI) at a speed of 0.8 mm/sec under a load of 1 kg.

The film may have a transmittance of about 88% or more, e.g., about 90% or more, or from about 90% to about 100%, in a wavelength band of 400 to 800 nm at a film thickness of 200 μm.

The film may have a glass transition temperature of about 250° C. or more, e.g., from about 290° C. to about 330° C.

The film may have has a thickness of about 50 μm to about 500 μm, e.g., from about 100 μm to about 300 μm.

In an example embodiment, the silsesquioxane-containing film may be a film that includes a silsesquioxane or a silsesquioxane resin.

In an example embodiment, the silsesquioxane-containing film may be a film formed of a cured product of a silsesquioxane or silsesquioxane resin-containing composition.

In an example embodiment, the silsesquioxane-containing film may be prepared by impregnating a reinforcing material into a matrix resin containing polyorganosiloxane or the like, followed by curing the resultant. Examples of the reinforcing material may include glass fibers, glass fiber cloth, glass fabrics, glass non-woven fabrics, glass meshes, glass beads, glass powders, glass flakes, silica particles, colloidal silica, mixtures thereof, etc.

In an example embodiment, the silsesquioxane-containing film may include a film prepared by coating a cured product of a silsesquioxane or silsesquioxane resin-containing composition on one or both sides of a transparent film.

In some example embodiments, the silsesquioxane-containing film may include a film laminate prepared by stacking a resin layer (e.g., having a transmittance of about 90% or more at a wavelength of 550 nm and a glass transition temperature of about 250° C. or more) and a transparent film (e.g., having a glass transition temperature of about 70° C. to about 220° C.).

The resin layer may be a cured product of a photocurable resin composition containing a photocurable cage-type silsesquioxane resin.

In an example embodiment, the cage-type silsesquioxane resin may be prepared through hydrolysis and partial condensation of a silicon compound represented by the following Formula 1 in the presence of an organic polar solvent and a basic catalyst, followed by condensation of the hydrolyzed product in the presence of a non-polar solvent and a basic catalyst:

RSiX₃, <Formula 1>

In Formula 1, R may be a (meth)acryloyl group, a glycidyl group, or a vinyl group, and X may be a hydrolysable group.

In an example embodiment, the cage-type silsesquioxane resin may be represented by Formula 2 or 3:

[RSiO_{3/2}]ₙ <Formula 2>

In Formula 2, R may be a (meth)acryloyl group, a glycidyl group, or a vinyl group, and n may be 8, 10, 12, or 14.

[R¹R²₂SiO_{1/2}]ₘ[R¹SiO_{3/2}]ₙ <Formula 3>

In Formula 3, R¹ may be a vinyl group, a C1-C10 alkyl group, a phenyl group, a (meth)acryloyl group, an allyl group, or an oxylane ring-containing group; at least two of (m+n) R¹ may be reactive organic functional groups having an unsaturated double bond, which may be selected from a vinyl group, a (meth)acryloyl group, or an allyl group; R² may be a methyl group; m may be an integer from 1 to 4; n may be an integer from 8 to 16; and m+n may range from 10 to 20.

The photocurable composition may include at least one or two of the silsesquioxane resins represented by Formula 2 or 3.

In an example embodiment, the cage-type silsesquioxane resin may be Formula 1 or 2, wherein R is represented by the following Formula 4, 5, or 6:

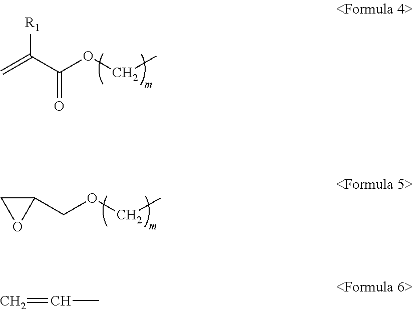

In Formulae 4 and 5, m maybe an integer from 1 to 3. In Formula 4, R¹ may be hydrogen or a methyl group.

The hydrolysable group X may be any suitable group exhibiting hydrolysis properties and may be, e.g., a C1 to C10 alkoxy group or an acetoxy group.

The transparent film may be formed of, e.g., polyethylene terephthalate, polyethylene naphthalate, polybutylene phthalate, cycloolefin polymer, cycloolefin copolymer, polycarbonate, acetate, acryl, polyvinyl fluoride, polyamide, polyarylate, cellophane, polyether sulfone, or norbornene resins.

The ratio of the thickness of the resin layer to the thickness of the transparent film may range from about 0.1 to about 5.0.

The silsesquioxane-containing film may be commercially obtained. For example, the silsesquioxane-containing film may be Silplus® J200 (Nippon Steel Chemical Group), etc.

The laminate may be prepared by a suitable method.

In an example embodiment, the laminate may be prepared by bonding the silsesquioxane-containing film to the base film using a bonding agent or adhesive.

In an example embodiment, the laminate may be prepared by coating the silsesquioxane-containing composition on the base film, followed by drying or curing the silsesquioxane-containing composition.

Adhesive Layer

The laminate may further include an adhesive layer between the base film and the silsesquioxane-containing film.

Referring to FIG. 1, the laminate 100 includes the base film 110, the first film 130 formed on the upper side of the base film 110 and containing silsesquioxane, and the first adhesive layer 120 formed between the base film 110 and the first film 130.

Referring to FIG. 2, the laminate 200 includes the base film 210, the first film 230b formed on the upper side of the base film 210 and containing silsesquioxane, the first adhesive layer 230b formed between the base film 210 and the first film 230b, the second film 230a formed on the lower side of the base film 210 and containing silsesquioxane, and the second adhesive layer 220a formed between the base film 210 and the second film 230a.

The adhesive layer may have a glass transition temperature of about −50° C. to about −10° C. Within this glass transition temperature range, the adhesive layer may help provide stable formation of the laminate and may prevent separation of the base film from the silsesquioxane-containing film. In an implementation, the adhesive layer may have a glass transition temperature from about −40° C. to about −10° C., e.g., from about −25° C. to about −10° C.

The glass transition temperature of the adhesive layer may be measured by a suitable method. For example, an adhesive composition may be coated on a release film, followed by drying and heat curing to form an adhesive layer. Then, the glass transition temperature of the adhesive layer may be measured using a DSC Q100 (TA Instrument) while being heated from −70° C. to 50° C. at a temperature-increase rate of 10° C./min.

The adhesive layer may have a modulus (G′) ranging from about 1×10⁴ to about 1.5×10⁶ dyn/cm². Within this modulus range, the adhesive layer may provide for stable formation of the laminate and may provide durability. In an implementation, the adhesive layer has a modulus (G′) from about 1×10⁵ to about 1.45×10⁶ dyn/cm².

The modulus of the adhesive layer may be measured by a suitable method. For example, the modulus of the adhesive layer may be measured using an ARES (Advanced Rheometric Expansion System, Rheometric Scientific Inc.) at a frequency of 10 rad/s and a strain of 5% in a temperature range from 25° C. to 70° C. at a temperature-increase rate of 2° C./min. Although a modulus may be obtained at 51.3° C., the present example embodiment is not limited thereto.

The adhesive layer may have a thickness from about 5 μm to about 50 μm, e.g., from about 10 μm to about 30 μm.

The adhesive layer may have an adhesive strength from about 2 N/inch to about 15 N/inch.

To measure the adhesive strength, an adhesive composition is coated to a thickness of 20 μm on a PET film, followed by drying and heat-curing the adhesive composition at 80° C. for 3 minutes to form an adhesive film, which in turn is left at 40° C. for 48 hours and combined with a general glass plate, then left again for 4 hours. Then, the adhesive strength of the film may be measured using an adhesive strength tester (Shinto Scientific, Heidon).

The adhesive layer may be formed of an adhesive composition containing a (meth)acrylic copolymer and a curing agent. In some example embodiments, the adhesive layer may be prepared by heat curing the adhesive composition at 80° C. for 180 seconds.

In an example embodiment, the laminate may be prepared by depositing and curing the adhesive composition between the base film and the silsesquioxane-containing film.

In an example embodiment, the laminate may be prepared by depositing the adhesive composition on a release film to form an adhesive film, which in turn is stacked between the base film and the silsesquioxane-containing film, followed by curing the adhesive.

Curing may include a heat curing process at about 50° C. to about 140° C. for about 1 minute to about 5 minutes. Deposition of the adhesive composition may be carried out using a die coater, gravure coater, micro-gravure coater, reverse coater, knife coater, comma coater, or the like.

The (meth)acrylic copolymer may have a glass transition temperature from about −50° C. to about −10° C., e.g., from about −40° C. to about −20° C.

The (meth)acrylic copolymer may be a copolymer of at least one monomer mixture selected from the group of a hydroxyl group-containing vinyl monomer, an alkyl group-containing vinyl monomer, a carboxylic acid group-containing vinyl monomer, and an aromatic group-containing vinyl monomer.

In an implementation, the (meth)acrylic copolymer is a copolymer of a monomer mixture including a hydroxyl group-containing vinyl monomer, an alkyl group-containing vinyl monomer, and a carboxylic acid group-containing vinyl monomer.

In an implementation, the (meth)acrylic copolymer is a copolymer of a monomer mixture including a hydroxyl group-containing vinyl monomer and an alkyl group-containing vinyl monomer.

The hydroxyl group-containing vinyl monomer may be a (meth)acrylic acid ester having a hydroxyl group. In an implementation, the (meth)acrylic acid ester having a hydroxyl group may be a (meth)acrylic acid ester which has at least one hydroxyl group and a C1 to C20 alkyl group at a terminal or in the molecular structure.

For example, the hydroxyl group-containing vinyl monomer may include at least one selected from the group of 2-hydroxyethyl(meth)acrylate, 4-hydroxybutyl(meth)acrylate, 2-hydroxypropyl(meth)acrylate, 2-hydroxybutyl(meth)acrylate, 6-hydroxyhexyl(meth)acrylate, 1,4-cyclohexanedimethanol mono(meth)acrylate, 1-chloro-2-hydroxypropyl(meth)acrylate, diethyleneglycol mono(meth)acrylate, 1,6-hexanediol mono(meth)acrylate, pentaerythritol tri(meth)acrylate, dipentaerythritol tri(meth)acrylate, neopentylglycol mono(meth)acrylate, trimethylolpropane di(meth)acrylate, trimethylolethane di(meth)acrylate, 2-hydroxy-3-phenyloxypropyl(meth)acrylate, 1,6-cyclohexanedimethanol mono(meth)acrylate, etc.

The hydroxyl group-containing vinyl monomer may be present in an amount of about 0.1 wt % to about 50 wt %, or about 0.1 wt % to about 5 wt %, or about 1 wt % to about 50 wt %, e.g., from about 1 wt % to about 3 wt % in the (meth)acrylic copolymer.

The alkyl group-containing vinyl monomer may include a (meth)acrylic acid ester having an acyclic, straight, or branched C1 to C20 alkyl group.

For example, the alkyl group-containing vinyl monomer may include at least one selected from the group of methyl(meth)acrylate, ethyl(meth)acrylate, propyl(meth)acrylate, n-butyl(meth)acrylate, t-butyl(meth)acrylate, isobutyl(meth)acrylate, pentyl(meth)acrylate, hexyl(meth)acrylate, 2-ethylhexyl(meth)acrylate, heptyl(meth)acrylate, octyl(meth)acrylate, isooctyl(meth)acrylate, nonyl(meth)acrylate, decyl(meth)acrylate, lauryl(meth)acrylate, etc.

The alkyl group-containing vinyl monomer may be present in an amount of about 50 wt % to about 99 wt %, e.g., about 55 wt % to about 99 wt % in the (meth)acrylic copolymer.

The carboxylic acid group-containing vinyl monomer may be a C1 to C10 (meth)acrylic acid ester having at least one carboxylic acid at a terminal or in the molecular structure, or a carboxylic acid having a vinyl group.

For example, the carboxylic acid group-containing vinyl monomer may be at least one selected from the group of (meth)acrylic acid, itaconic acid, crotonic acid, maleic acid, fumaric acid, maleic acid anhydride, etc.

The carboxylic acid group-containing vinyl monomer may be present in an amount of about 0 to about 40 wt % in the (meth)acrylic copolymer. Within this range, the carboxylic acid group-containing vinyl monomer may improve adhesion. In an implementation, the carboxylic acid group-containing vinyl monomer is present in an amount of about 0.1 wt % to about 40 wt % in the (meth)acrylic copolymer.

The aromatic group-containing vinyl monomer may include a (meth)acrylate having an aromatic compound represented by Formula 7:

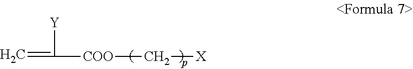

In Formula 7, Y may be hydrogen or a C1-C5 alkyl group; p may be an integer ranging from 0 to 10; and X may be selected from the group of a phenyl group, a methylphenyl group, a methylethylphenyl group, a methoxyphenyl group, a propylphenyl group, a cyclohexylphenyl group, a chlorophenyl group, a bromophenyl group, a phenylphenyl group, a benzyl group, and a benzylphenyl group.

For example, the vinyl monomer represented by Formula 7 may include at least one selected from the group of phenyl(meth)acrylate, phenoxy(meth)acrylate, 2-ethylphenoxy(meth)acrylate, benzyl(meth)acrylate, 2-phenylethyl(meth)acrylate, 3-phenylpropyl(meth)acrylate, 4-phenylbutyl(meth)acrylate, 2-(2-methylphenyl)ethyl(meth)acrylate, 2-(3-methylphenyl)ethyl(meth)acrylate, 2-(4-methylphenyl)ethyl(meth)acrylate, 2-(4-propylphenyl)ethyl(meth)acrylate, 2-(4-(1-methylethyl)phenyl)ethyl(meth)acrylate, 2-(4-methoxyphenyl)ethyl(meth)acrylate, 2-(4-cyclohexylphenyl)ethyl(meth)acrylate, 2-(2-chlorophenyl)ethyl(meth)acrylate, 2-(3-chlorophenyl)ethyl(meth)acrylate, 2-(4-chlorophenyl)ethyl(meth)acrylate, 2-(4-bromophenyl)ethyl(meth)acrylate, 2-(3-phenylphenyl)ethyl(meth)acrylate, benzyl(meth)acrylate, 2-(4-benzylphenyl)ethyl(meth)acrylate, etc.

The aromatic group-containing vinyl monomer may be included as a (meth)acrylic copolymer, which may help improve processability and suppress stress at high temperatures.

The (meth)acrylic copolymer may be prepared by a suitable method such as solution polymerization, light polymerization, bulk polymerization, suspension polymerization, or emulsion polymerization. In an implementation, the (meth)acrylic copolymer is prepared via solution polymerization at a polymerization temperature from about 50° C. to about 140° C.

In polymerization of the (meth)acrylic copolymer, an initiator may be used. The initiator may be a suitable initiator including, e.g., azo-based polymerization initiators such as azobisisobutyronitrile or azobiscyclohexanecarbonitrile, and/or peroxides such as benzoyl peroxide or acetyl peroxide.

The curing agent may be present in an amount of about 0.01 to 5 parts by weight based on 100 parts by weight of the (meth)acrylic copolymer. Within this range of the curing agent, adhesive layer may have a desired glass transition temperature, and the adhesive composition may provide improved durability and reworkability. For example, the curing agent may be present in an amount of about 0.1 to 3 parts by weight.

The curing agent may be selected from the group of isocyanate, epoxy, aziridine, melamine, amine, imide, carbodiimide, amide curing agents, mixtures thereof, etc.

The adhesive composition may further include additives. The additives may include coupling agents, curing accelerators, tackifier resins, reforming resins (polyol, phenol, acryl, polyester, polyolefin, epoxy, epoxylated poly-butadiene resins, etc.), UV absorbers, leveling agents, antifoaming agents, plasticizers, dispersants, heat stabilizers, light stabilizers, anti-static agents, a mixture thereof, etc.

The additives may be present in an amount of, e.g., about 0.05 wt % to about 15 wt % in the adhesive composition.

The adhesive composition may further include a solvent. The solvent may include, e.g., methylethylketone, methylisobutylketone, acetone, cyclohexanone, cyclopentanone, dioxolane, dioxane, dimethoxyethane, toluene, xylene, ethyl acetate, a mixture thereof, etc.

The adhesive composition may be prepared by mixing the (meth)acrylic copolymer, the curing agent, and any additives.

Coating Layer

The laminate may further include a coating layer. In some example embodiments, the coating layer may be formed on at least one side of the silsesquioxane-containing film.

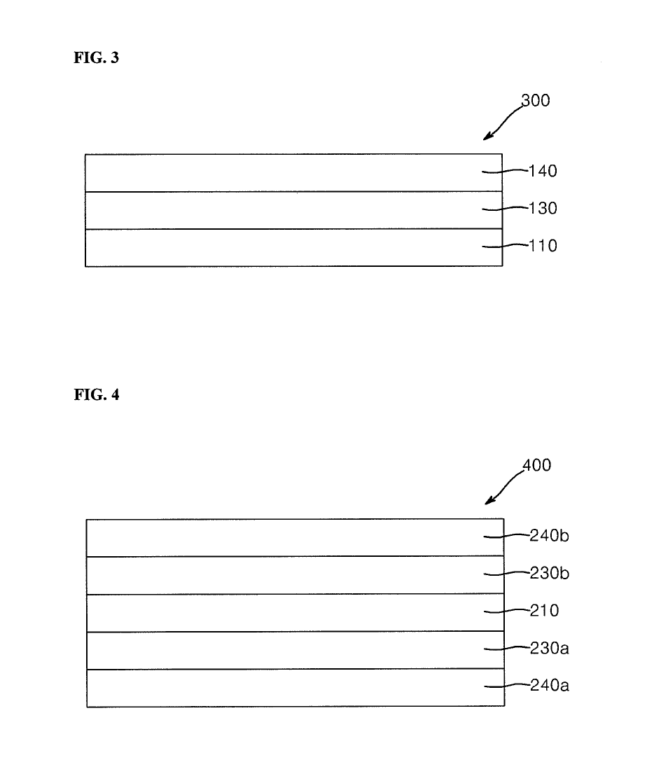

FIGS. 3 and 4 illustrate sectional views of laminates according to example embodiments.

Referring to FIG. 3, a laminate 300 includes a base film 110, a first film 130 formed on an upper side of the base film 110 and containing silsesquioxane, and a first coating layer 140 formed on an upper side of the first film 130.

Referring to FIG. 4, a laminate 400 includes a base film 210, a first film 230b formed on an upper side of the base film 210 and containing silsesquioxane, a second film 230a formed on a lower side of the base film 210 and containing silsesquioxane, a first coating layer 240b formed on an upper side of the first film 230b, and a second coating layer 240a formed on a lower side of the second film 230a.

The coating layer may have a water contact angle of about 80° or more or a hexadecane contact angle of about 25° or more at 25° C. Within this range of the contact angle, the coating layer may provide low surface energy to exhibit good anti-fouling and fingerprint repellent properties, and may provide a high pencil hardness of 6 H or more while exhibiting good scratch resistance.

The coating layer may have a water contact angle of about 80° to about 110°, e.g., about 86° to about 108°. The coating layer may have a hexadecane contact angle of about 25° to about 80°, e.g., about 27° to about 50°.

The water contact angle and the hexadecane contact angle may be measured by respectively placing a droplet of water or hexadecane on a surface of the coating layer, and measuring an angle between the droplet and the surface of the coating layer at 25° C. using a contact angle tester (for example, Surface Electro Optics, Phoenix 300).

The coating layer may have a pencil hardness of about 6 H or more, e.g., about 6 H to about 7 H.

The pencil hardness may be determined using a Pencil Hardness/Scratch Resistance Tester (14FW, Heidon) with respect to a laminate having a thickness of 100 μm to 300 μm. In the laminate for measurement of pencil hardness, the base film having a resin layer containing silsesquioxane stacked thereon may have a thickness of 100 μm to 300 μm, and the coating layer may have a thickness of 10 nm to 500 nm.

The coating layer may have a reflectivity of about 2% or less at a wavelength of 550 nm. Within this range, the coating layer may achieve anti-reflection and anti-glare functions, and the laminate may be used for the window sheet. The coating layer may have a reflectivity of about 0.1% to about 1.8%, e.g., about 0.5% to about 1.5% or about 0.9% to about 1.4%.

The coating layer may have a transmittance of about 90% or more at wavelengths of 400 nm to 800 nm. Within this range of transmittance, the coating layer exhibit good transmittance, thereby allowing the laminate to be used for the window sheet. In an implementation, the coating layer has a transmittance of about 90% to about 100%.

The thickness of the coating layer may be determined according to the thickness of the final laminate, the silsesquioxane-containing film, the resin layer containing silsesquioxane, or the base film. In some example embodiments, the coating layer may have a thickness of about 10 nm to about 500 nm as determined by taking transmittance of the window sheet.

The coating layer may include a single layer. The coating layer that includes a single layer may also provide high transmittance as in a conventional anti-reflection film and may allow adjustment of reflectivity and color sense.

The coating layer may include a cured product of a composition including a (meth)acrylate-based compound, inorganic nanoparticles, and an initiator.

As used herein, “(meth)acrylate-based” may refer to both acrylate and methacrylate compounds.

In an example embodiment, the (meth)acrylate-based compound may contain fluorine.

In an example embodiment, the coating layer may be formed of a composition including a fluorine-containing (meth)acrylate-based compound and inorganic nanoparticles.

In the fluorine-containing (meth)acrylate-based compound, fluorine may improve fingerprint repellency and anti-fouling properties of the coating layer, and a (meth)acrylate functional group may form a matrix of the coating layer.

The fluorine-containing (meth)acrylate-based compound may include a fluorine-modified (meth)acrylate copolymer, a fluorine-modified (meth)acrylate monomer, or a mixture thereof. In an implementation, at least two copolymers or monomers having a different number of functional groups are used to enhance effects to the coating layer in terms of refractivity and coating strength.

The fluorine-modified (meth)acrylate copolymer may be a mono- or more functional, bi- or more functional group, or tri- or more functional fluorine-containing (meth)acrylate copolymer. In an implementation, the fluorine-modified (meth)acrylate copolymer is a bi- or more functional, e.g., tri- or more functional, fluorine-modified (meth)acrylate copolymer.

The fluorine-modified (meth)acrylate copolymer may have a weight average molecular weight of about 500 g/mol or more, e.g., from about 500 g/mol to about 10,000 g/mol.

The fluorine-modified (meth)acrylate monomer may be a mono-functional, bi-functional, or tri-functional, fluorine-containing (meth)acrylate monomer.

The fluorine-modified (meth)acrylate monomer may have a weight average molecular weight of less than about 500 g/mol, e.g., from about 200 g/mol to about 400 g/mol.

The composition for the coating layer may include both the fluorine-modified (meth)acrylate copolymer and the fluorine-modified (meth)acrylate monomer, in which the content ratio of the fluorine-modified (meth)acrylate monomer (b) to the fluorine-modified (meth)acrylate copolymer (a) (b/a, in terms of weight) may range from about 0.1 to about 6, e.g., from about 0.2 to about 5.5.

The fluorine-modified (meth)acrylate monomer may include an alkyl(meth)acrylate containing a C1 to C18, e.g., C2 to C11, fluoroalkyl group, or a C1 to C18, e.g., C4 to C11, perfluoroalkyl group. In some example embodiments, the monomer may include at least one of trifluoroethyl(meth)acrylate, tetrafluoropropyl(meth)acrylate, and (perfluorooctyl)ethyl(meth)acrylate, etc.

In the composition for the coating layer, the fluorine-containing (meth)acrylate-based compound may be present in an amount of about 50 to 99 parts by weight based a total of 100 parts by weight of the fluorine-containing (meth)acrylate-based compound and the inorganic nanoparticles. Within this range, the coating layer may provide excellent anti-fouling, oil repellency and low reflective properties. The fluorine-containing (meth)acrylate-based compound may be present in an amount of about 60 to 95 parts by weight, e.g., about 60 to 92 parts by weight.

The fluorine-containing (meth)acrylate-based compound may be present in an amount of about 40 to 95 parts by weight in the composition for the coating layer in terms of solid content. Within this range, the coating layer may provide excellent anti-fouling, oil repellent, and low reflective properties. In an implementation, the fluorine-containing (meth)acrylate-based compound is present in an amount of about 50 to 92 parts by weight, e.g., about 59 to 92 parts by weight.

The inorganic nanoparticles may include hollow silica, reactive silica, or a mixture thereof.

The inorganic nanoparticles may have, e.g., a spherical, flake, or amorphous shape, e.g., a spherical shape.

As used herein, the term “hollow silica” may refer to silica particles prepared from an inorganic silicon compound or an organic silicon compound, in which a void is present on the surface and/or the interior of the silica particle.

The hollow silica particles may have an average particle size (diameter) from about 5 nm to about 300 nm, e.g., from about 10 nm to about 250 nm, and a specific surface area from about 50 m²/g to about 1500 m²/g.

The hollow silica may be subjected to surface treatment with a fluorine compound. The fluorine compound may include fluorine and a (meth)acrylate functional group (for example, an acryl binder). The fluorine compound may include a fluorine-modified (meth)acrylate monomer.

The hollow silica may include about 1 wt % to about 99 wt % of silica and about 1 wt % to about 99 wt % of an acryl binder. In an implementation, the hollow silica includes about 40 wt % to about 60 wt % of silica and about 40 wt % to about 60 wt % of an acryl binder.

As used herein, the term “reactive silica” may refer to silica particles prepared from a inorganic silicon compound or an organic silicon compound, in which the surface and the interior of the particle is completely filled so as not to form a void on the surface and/or the interior thereof, unlike the hollow silica.

The reactive silica may have an average particle size (diameter) from about 5 nm to about 300 nm, e.g., from about 10 nm to about 250 nm. Within this range of the particle size, the coating layer may exhibit excellent surface strength and scratch resistance.

The reactive silica may be subjected to surface treatment with a (meth)acrylate-based compound. About 3% to about 50% of the entire surface area of the reactive silica may be subjected to surface treatment with the (meth)acrylate-based compound. Within this range, the silica particles may be uniformly distributed and exhibit transparency.

Examples of the (meth)acrylate-based compound may include a (meth)acrylic acid ester having a C1 to C20 linear or branched alkyl group, a (meth)acrylic acid ester having a hydroxyl group and a C1 to C20 alkyl group, a (meth)acrylic monomer which has a C4 to C20 homogeneous or heterogeneous alicyclic ring including nitrogen, oxygen or sulfur, a (meth)acrylic acid ester having a C4 to C20 homogeneous or heterogeneous alicyclic ring, a (meth)acrylate having a C6 to C20 aryl group, aryloxy group or aralkyl group, and mixtures thereof. For example, the (meth)acrylate-based compound may include methyl(meth)acrylate, butyl(meth)acrylate, or the like.

Surface treatment of the silica with the (meth)acrylate-based compound may be carried out by a suitable method. For example, the silica particles may be subjected to surface treatment using a mono-functional methoxy/ethoxy or polyfunctional methoxy/ethoxy acrylate silane, etc.

In the composition for the coating layer, the inorganic nanoparticles may be present in an amount of about 1 to 50 parts by weight based on a total of 100 parts by weight of the fluorine-containing (meth)acrylate-based compound and the inorganic nanoparticles. Within this range of the inorganic nanoparticles, the coating layer may exhibit low reflectivity. In an implementation, the inorganic nanoparticles are present in an amount of about 5 to 40 parts by weight, e.g., about 8 to 40 parts by weight.

The inorganic nanoparticles may be present in an amount of about 1 to 50 parts by weight, e.g., about 5 to 38 parts by weight, in the composition for the coating layer in terms of solid content.

The composition for the coating layer may further include an initiator.

The initiator may include any photo-polymerization initiator known in the art. Examples of photo-polymerization initiators applicable to the present example embodiment include triazine, acetophenone, benzophenone, thioxanthone, benzoin, phosphorous, oxime-based compounds, mixtures thereof, etc.

The initiator may be present in an amount of about 0.1 to 10 parts by weight in the composition for the coating layer in terms of solid content. Within this range of the initiator, the composition may be sufficiently cured to form the coating layer and does not remain after reaction, thereby preventing deterioration in transparency. In an implementation, the initiator is present in an amount of about 0.1 to 5 parts by weight in the composition.

In an example embodiment, the (meth)acrylate-based compound may be free from fluorine.

In an example embodiment, the coating layer may be formed of a composition that includes a UV curable resin, a polyfunctional (meth)acrylate monomer, inorganic nanoparticles, a silicon-modified polyacrylate, and an anti-foaming agent.

The UV curable resin may include a resin containing a (meth)acrylate-based functional group.

In an example embodiment, the UV curable resin may include urethane resins, polyester resins, polyether resins, acryl resins, epoxy resins, alkyd resins, spiroacetal resins, polybutadiene resins, polythiol polyene resins, (meth)acrylate resins of polyfunctional compounds such as polyhydric alcohols, or the like.

In an example embodiment, the UV curable resin may include at least one selected from the group of polyester(meth)acrylate obtained by esterification of mono- or polyfunctional and mono or polyhydric alcohol (meth)acrylates, polybasic carboxylic acid and anhydrides thereof, and/or (meth)acrylic acids, wherein the mono- or polyfunctional and mono or polyhydric alcohol (meth)acrylates include ethylene glycol di(meth)acrylate, neopentyl glycol di(meth)acrylate, 1,6-hexanediol(meth)acrylate, trimethylolpropane tri(meth)acrylate, dipentaerythritol hexa(meth)acrylate, polyol poly(meth)acrylate, bisphenol A-diglycidyl ether di(meth)acrylate, and the like; polysiloxane-polyacrylate, urethane(meth)acrylate, aromatic urethane resins, and aliphatic urethane resins, etc.

The UV curable resin may further include a hydroxyl group-containing (meth)acrylate. Examples of the hydroxyl group-containing (meth)acrylate may include 2-hydroxyethyl(meth)acrylate, 2-hydroxypropyl(meth)acrylate, pentaerythritol tri(meth)acrylate, 2,3-dihydroxypropyl(meth)acrylate, 4-hydroxymethylcyclohexyl(meth)acrylate, or the like.

The UV curable resin may be a fluorine-containing resin such as fluorine-containing epoxy acrylate, fluorine-containing alkoxysilane, or the like. Examples of the fluorine-containing resin may include 2-(perfluorodecyl)ethyl(meth)acrylate, 3-perfluorooctyl-2-hydroxypropyl(meth)acrylate, 3-(perfluoro-9-methyldecyl)-1,2-epoxypropane, (meth)acrylate-2,2,2-trifluoroethyl, (meth)acrylate-2-trifluoromethyl, (meth)acrylate-trifluoromethyl, (meth)acrylate-3,3,3-trifluoropropyl, etc.

In the composition for the coating layer, the UV curable resin may be present in an amount of about 30 to 70 parts by weight based on a total of 100 parts by weight of the UV curable resin, the polyfunctional (meth)acrylate monomer, and the inorganic nanoparticles. Within this range, the coating layer may exhibit high hardness and low curling effects. In an implementation, the UV curable resin is present in an amount of about 40 to 60 parts by weight.

The polyfunctional (meth)acrylate monomer may be a bi- or more functional (meth)acrylate monomer, e.g., a hexa- or more functional (meth)acrylate monomer.

In an example embodiment, the polyfunctional (meth)acrylate monomer may be at least one selected from the group of ethylene glycol di(meth)acrylate, diethyleneglycol di(meth)acrylate, triethylene glycol di(meth)acrylate, 1,4-butandiol di(meth)acrylate, 1,6-hexanediol di(meth)acrylate, neopentyl glycol di(meth)acrylate, pentaerythritol di(meth)acrylate, pentaerythritol tri(meth)acrylate, dipentaerythritol di(meth)acrylate, dipentaerythritol tri(meth)acrylate, dipentaerythritol penta(meth)acrylate, dipentaerythritol hexa(meth)acrylate, bisphenol A di(meth)acrylate, trimethylolpropane tri(meth)acrylate, novolac epoxy(meth)acrylate, propylene glycol di(meth)acrylate, etc.

In the composition for the coating layer, the polyfunctional (meth)acrylate monomer may be present in an amount of about 5 to 25 parts by weight based on a total of 100 parts by weight of the UV curable resin, the polyfunctional (meth)acrylate monomer, and the inorganic nanoparticles. Within this range, the coating layer may exhibit good hardness and surface hardening effects. In an implementation, the polyfunctional (meth)acrylate monomer is present in an amount of about 10 to 20 parts by weight.

The inorganic nanoparticles may include the aforementioned hollow silica, reactive silica, or a mixture thereof.

In the composition for the coating layer, the inorganic nanoparticles may be present in a balance amount based on a total amount of 100 parts by weight of the UV curable resin, the polyfunctional acrylate monomer, and the inorganic nanoparticles. Within this range of the inorganic nanoparticles, the coating layer may provide good hardness and scratch resistance. In an implementation, the inorganic nanoparticles are present in an amount of about 0 to 50 parts by weight, e.g., about 5 to 45 parts by weight or about 20 to 45 parts by weight.

The silicon-modified polyacrylate may improve fingerprint repellency of the coating layer by improving the water contact angle or the hexadecane contact angle of the coating layer together with the anti-foaming agent.

The silicon-modified polyacrylate may be a polyacrylate containing at least one silicon atom. In an implementation, the silicon-modified polyacrylate has at least one terminal hydroxyl group. The hydroxyl group may allow the silicon-modified polyacrylate to be directly inserted into and secured to a polymer matrix composed of the UV curable resin, the polyfunctional acrylate monomer, and the inorganic nanoparticles constituting the coating layer.

For example, the silicon-modified polyacrylate may have a structure in which at least one hydroxyl group is bonded to non-polar polysiloxane. Specifically, the silicon-modified polyacrylate may include methacrylate-polysiloxane, vinyl polysiloxane, etc.

The silicon-modified polyacrylate may have an acid value of about 20 mgKOH/g to about 40 mgKOH/g in terms of solid content. Within this range of the acid value, the coating layer may exhibit excellent fingerprint repellency.

The silicon-modified polyacrylate may be obtained by a typical preparation method or may be commercially obtained from the market. For example, commercially available silicon-modified polyacrylate products include BYK®-SILCLEAN 3700 (BYK Chemie), BYK®-SILCLEAN 3720 (BYK Chemie), etc.

In the composition for the coating layer, the silicon-modified polyacrylate may be present in an amount of about 0.1 to 5 parts by weight based on a total of 100 parts by weight of the UV curable resin, the polyfunctional (meth)acrylate monomer, and the inorganic nanoparticles. Within this range of the silicon-modified polyacrylate, the coating layer may exhibit a high water contact angle and may exhibit improved fingerprint repellency. In an implementation, the silicon-modified polyacrylate may be present in an amount of about 0.5 to 2.0 parts by weight.

The anti-foaming agent may improve fingerprint repellency by improving the water contact angle or the hexadecane contact angle of the coating layer together with the silicon-modified polyacrylate.

The anti-foaming agent may be, e.g., a silicone-based anti-foaming agent such as dimethylpolysiloxane, organic modified polysiloxane, or the like. In an implementation, the anti-foaming agent is a fluorine-modified polysiloxane. A commercially obtainable anti-foaming agent, for example, BYK 065 (BYK Chemie), may be used.

In the composition for the coating layer, the anti-foaming agent may be present in an amount of about 0.01 to 5 parts by weight based on a total of 100 parts by weight of the UV curable resin, the polyfunctional (meth)acrylate monomer and the inorganic nanoparticles. Within this range, the anti-foaming agent may form pin holes together with the silicon-modified polyacrylate, thereby increasing the water contact angle of the coating layer while improving fingerprint repellency. In an implementation, the anti-foaming agent is present in an amount of about 0.1 to 2 parts by weight, e.g., about 0.25 to 1 part by weight.

In the coating layer or the composition for the coating layer, a weight ratio of the silicon-modified polyacrylate to the anti-foaming agent (the silicon-modified polyacrylate: the anti-foaming agent) may range from about 1:0.25 to about 1:1. Within this range, the water contact angle of the coating layer may be increased, and the fingerprint repellency may be improved.

The composition may further include an initiator.

The initiator may include a typical photocurable initiator known in the art. In some example embodiments, the composition may include the aforementioned photo-polymerization initiator.

In the composition for the coating layer, the initiator may be present in an amount of about 0.1 to 10 parts by weight based on a total of 100 parts by weight of the UV curable resin, the polyfunctional (meth)acrylate monomer, and the inorganic nanoparticles.

In addition to the aforementioned components, the composition for the coating layer may further include a solvent and additives as needed. The additives may include, e.g., one or more of photosensitizers, photo-desensitizing agents, polymerization inhibitors, leveling agents, wettability improvers, surfactants, plasticizers, ultraviolet absorbers, antioxidants, or inorganic fillers.

The additives may be present in an amount of about 1 to 20 parts by weight based on a total of 100 parts by weight of the fluorine-containing (meth)acrylic compound and the inorganic nanoparticles.

Further, the additives may be present in an amount of about 1 to 20 parts by weight based on a total of 100 parts by weight of the UV curable resin, the polyfunctional (meth)acrylate monomer, and the inorganic nanoparticles.

The coating layer may be formed by a suitable method using the composition for the coating layer. For example, the coating layer may be formed by coating and drying the composition for the coating layer on the resin layer containing the silsesquioxane (for example: coating thickness of about 100 nm to 200 μm), followed by curing through UV irradiation using a metal halide lamp or the like.

Functional layers such as an adhesive layer, a highly refractive layer, an anti-static layer, a primer coating layer, or the like may be further stacked between the silsesquioxane-containing film and the coating layer.

Hard Coating Layer

The laminate may further include a hard coating layer to prevent scratching and depression during a process while improving durability, impact resistance, and hardness of the laminate.

The hard coating layer may be formed on one side of the laminate, e.g., on the uppermost layer of the laminate.

The hard coating layer may have a pencil hardness of about 2 H to 3 H, as determined by Pencil Hardness Tester (Shinto Scientific, Heidon) using Mitsubishi Pencil (UNI) after drawing a line at a speed of 0.8 mm/sec under a load of 1 kg.

The hard coating layer may have a thickness of about 0.5 μm to about 10 μm.

The hard coating layer may be formed of a coating liquid that includes a curing agent and a UV curable material such as urethane compounds, etc.

The laminate may have a pencil hardness of about 6 H or more, e.g., about 6 H to about 7 H. The pencil hardness may be measured using a pencil hardness/scratch resistance tester (14FW, Heidon) with respect to a 100 to 300 μm thick laminate. In an implementation, in the laminate for determination of pencil hardness, the base film having the silsesquioxane-containing film stacked thereon has a thickness of 100 μm to 300 μm, and the coating layer has a thickness of 10 nm to 500 nm.

The laminate may exhibit excellent impact resistance, high hardness, scratch resistance, anti-glare, anti-reflection, and anti-fouling properties. The laminate may have high functionality by improving impact resistance of a high hardness resin film, and adding a coating layer having anti-glare, low refractivity, and anti-fouling properties to the resin film.

The laminate may be used for a window sheet.

A general high hardness window sheet may be provided anti-reflection, low refractivity and anti-fouling properties, by a deposition method on a finished high hardness window sheet. In other words, the high hardness window sheet may be made through deposition instead of roll coating due to low flexibility thereof. However, according to an example embodiment, the laminate may provide anti-reflection and anti-fouling functions even when made through roll-to-roll type wet coating.

In accordance with an example embodiment, a display apparatus including the laminate is provided. The display apparatus may includes a window sheet, and a liquid crystal panel formed under the window sheet, wherein the window sheet includes the laminate according to an embodiment. Examples of the display apparatus may include mobile phones, liquid crystal display apparatuses, etc.

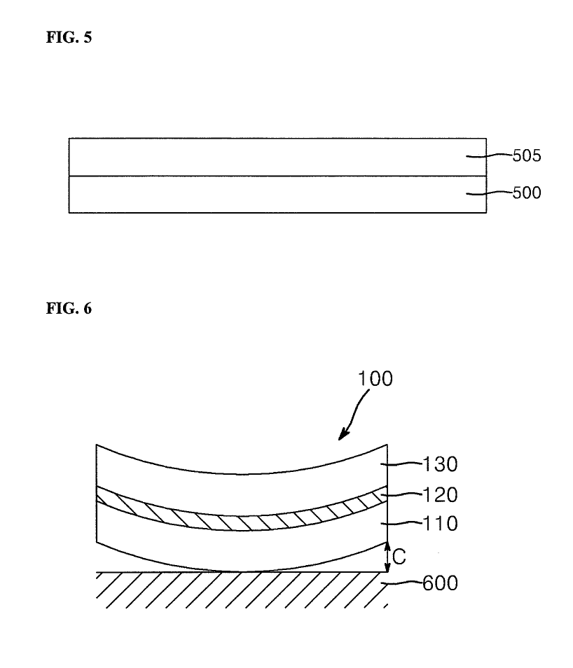

FIG. 5 illustrates a sectional view of a display apparatus in accordance with an example embodiment.

Referring to FIG. 5, the display apparatus may include a liquid crystal panel 500, and a window sheet 505 formed on upper side of the liquid crystal panel 500.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

(1) Details of components used in Examples 1 to 7 and Comparative Examples 1 to 4 are as follows:

(A) Silsesquioxane-containing film: POS (polyhedral oligomeric silsesquioxane) containing film (Silplus® J200, Nippon Steel Chemical Group, thickness: 200 μm)

(B) Adhesive: Adhesive compositions prepared in Preparative Example 1 to 5

(C) Base film: Base film listed in Table 1

TABLE 1

| | Impact | | Thick- | |
|---|---|---|---|---|
| | resistance | | ness | |
| Sample No. | (J)* | Material | (mm) | Remarks |
| Base film 1 | 5.42 | Polycarbonate | 0.8 | Cheil Industries Inc. |
| Base film 2 | 5.42 | Polycarbonate | 0.5 | Cheil Industries Inc. |
| Base film 3 | 16.27 | Polymethyl | 0.8 | K-HI30-U25, |
| | | methacrylate + | | KURARAY |
| | | Rubber | | |
| Base film 4 | 3.25 | Polymethyl | 1 | Cheil Industries Inc. |
| | | methacrylate | | |
| Base film 5 | 3.25 | Polycarbonate | 0.2 | Cheil Industries Inc. |

*Impact resistance: determined using a DuPont drop impact tester according to ASTM D 4226 under a load of 500 g for a specimen having a size of 30 mm × 70 mm × the sample thickness (unit: mm),

### Preparative Example 1

### Preparation of Adhesive Composition

To a 1 L reactor equipped with a cooling device for temperature control, 99 parts by weight of n-butyl acrylate (BA) and 1 part by weight of 4-hydroxybutyl acrylate (4-HBA) were added under a nitrogen atmosphere. Further, 120 parts by weight of ethyl acetate was added. After removing oxygen from the reactor by purging with nitrogen gas for 60 minutes, the reactor was maintained at 60° C., and 0.05 parts by weight of 2,2′-azobisisobutyronitrile (AIBN) (based on 100 parts by weight of an acrylic copolymer) was added as a reaction initiator. The acrylic copolymer was prepared through reaction at 60° C. for 8 hours.

100 parts by weight (1986 g) of the prepared acrylic copolymer, 1.9 parts by weight (60 g) of a curing agent (L-45R, Soken), and 40 parts by weight (900 g) of methylethylketone were stirred at room temperature for 45 minutes to prepare an adhesive composition.

### Preparative Examples 2-5

### Preparation of Adhesive Composition

Adhesive compositions were prepared in the same manner as in Preparative Example 1 except for the monomer contents of the copolymer (unit: parts by weight), the kind and content of curing agent (unit: parts by weight) as listed in Table 2.

TABLE 2

| | | Preparative | Preparative | Preparative | Preparative | Preparative |
|---|---|---|---|---|---|---|
| | | Example 1 | Example 2 | Example 3 | Example 4 | Example 5 |
| (Meth)acrylic | BA | 99 | 55 | 99 | 50 | 99 |
| copolymer | 4-HBA | 1 | 5 | 1 | 5 | 1 |
| | MA | — | 40 | — | 35 | — |
| | Vinyl | — | — | — | 10 | — |
| | resin | | | | | |
| Curing | Curing | 1.9 | — | 1.9 | — | — |
| agent | agent 1 | | | | | |
| | Curing | — | 0.15 | — | 0.2 | — |
| | agent 2 | | | | | |

| | | | | | |
|---|---|---|---|---|---|
| Methylethylketone | 40 | 45 | 40 | 40 | 40 |
| Additives | — | — | 1.5 | — | — |
| Glass transition | −24.81 | −13.83 | −24.81 | −8.35 | −56 |
| temperature (° C.) | | | | | |
| Modulus (dyn/cm²) | 1.43 × 10⁶ | 1.12 × 10⁶ | 1.43 × 10⁶ | 1.85 × 10⁶ | 7.07 × 10⁵ |

MA: methacrylic acid
Curing agent 1: L-45R (Soken)
Curing agent 2: DN 950 (Aekyung)
Additives: UV absorber Tinuvin 384
Vinyl resin: Hydroxyl-Modified Vinyl Chloride/Vinyl Acetate Copolymer (Dow Chemical)
Glass transition temperature: Glass transition temperature measured from after curing product of the adhesive composition. A mixture of the copolymer and the curing agent was coated on a release film (PET), followed by drying and heat curing at 80° C. for 3 minutes. The glass transition temperature was measured using a tester DSC Q100 (TA Instrument) while increasing the temperature from −70° C. to 50° C. at a temperature-increase rate of 10° C./min.
Modulus: The modulus of the adhesive composition was measured using ARES in a temperature range of 25~70° C. at a frequency of 10 rad/s, a strain of 5%, and a temperature-increase rate of 2° C./min. G′ value at 51.3° C. was recorded.

### Example 1

The adhesive composition prepared in Preparative Example 1 was coated and dried on a polyethylene terephthalate release film, thereby preparing a 20 μm thick adhesive film. The prepared adhesive film was subjected to aging at 40° C. for 48 hours. The adhesive film and a silsesquioxane-containing film were sequentially stacked on the base film of Table 1, followed by combination at room temperature using a Pol attacher, thereby preparing a laminate having the structure of FIG. 1.

### Examples 2 to 7

Laminates were prepared in the same manner as in Example 1 except for the kind of adhesive composition and the kind of base film were varied as listed in Table 3.

TABLE 3

| | Example | | | | | | |
|---|---|---|---|---|---|---|---|
| | 1 | 2 | 3 | 4 | 5 | 6 | 7 |
| Adhesive | Prep. | Prep. | Prep. | Prep. | Prep. | Prep. | Prep. |
| composition | Example 1 | Example 2 | Example 2 | Example 2 | Example 2 | Example 3 | Example 1 |
| Base film | Base film 1 | Base film 1 | Base film 1 | Base film 1 | Base film 2 | Base film 1 | Base film 3 |
| Thickness of | 20 | 20 | 20 | 10 | 10 | 20 | 20 |
| adhesive | | | | | | | |
| layer (μm) | | | | | | | |
| Laminate | FIG. 1 | FIG. 1 | FIG. 1 | FIG. 1 | FIG. 2 | FIG. 1 | FIG. 1 |
| structure | | | | | | | |
| Thickness of | 1.02 | 1.02 | 1.02 | 1.01 | 0.92 | 1.02 | 1.02 |
| laminate | | | | | | | |
| (mm) | | | | | | | |

### Comparative Examples 1 to 4

Laminates were prepared in the same manner as in Example 1 except for the kind of adhesive and the kind of base film as listed in Table 4.

TABLE 4

| | Comparative Example | | | |
|---|---|---|---|---|
| | 1 | 2 | 3 | 4 |
| Adhesive | Preparative | Preparative | Preparative | Preparative |
| composition | Example 4 | Example 5 | Example 1 | Example 2 |
| Base film | Base film 1 | Base film 1 | Base film 4 | Base film 5 |
| Thickness of | 20 | 20 | 10 | 10 |
| adhesive layer | | | | |
| (μm) | | | | |
| Laminate | FIG. 1 | FIG. 1 | FIG. 1 | FIG. 1 |
| structure | | | | |
| Thickness of | 1.02 | 1.02 | 1.02 | 0.41 |
| laminate (mm) | | | | |

The laminates prepared in Examples 1 to 7 and Comparative Examples 1 to 4 were evaluated as to the following properties, and results are listed in Table 5.

Evaluation of Physical Properties

1. Impact resistance: With the laminate (length×width, 5 cm×6 cm) fixed in a ball drop tester, a 36 g steel ball was dropped from a height of 50 cm onto a central point of the laminate. Drop testing was repeated three times under the same conditions, and no cracking of the laminate is denoted by O and cracking of the laminate is denoted by X.

2. Curling height: After the laminate (length×width×thickness, 15 cm×15 cm×thickness of laminate of Tables 3 and 4) were left under conditions of 85° C./85% RH for 72 hours, and then left at 25° C. for 4 hours. A maximum curled height of the laminate from a bottom was measured using a gap gauge. See FIG. 6. Referring to FIG. 6, a curling height refers to a maximum curled height (C) of a laminate 100 from a bottom 600. Here, the laminate 100 includes an adhesive layer 120 and a silsesquioxane-containing film 130 stacked on a base film 110.

3. Transmittance: Transmittance was measured in a wavelength band of 400 to 800 nm using a transmittance tester Lambda 950 (Perkin Elmer).

4. Separation: The laminate was left for 72 hours under high temperature/high humidity chamber conditions at 85° C. and 85% RH (New power Eng.), and then left at room temperature for 4 hours. Separation between the plastic sheet and the silsesquioxane film was determined through observation with the naked eye. Separation is denoted by O and no separation is denoted by X.

TABLE 5

| | Example | | | | | | | Comparative Example | | | |
|---|---|---|---|---|---|---|---|---|---|---|---|
| | 1 | 2 | 3 | 4 | 5 | 6 | 7 | 1 | 2 | 3 | 4 |
| Impact | ∘ | ∘ | ∘ | ∘ | ∘ | ∘ | ∘ | x | ∘ | x | x |
| resistance | | | | | | | | | | | |
| Curling | 3 | 3 | 3 | 1 | 0.8 | 3 | 4 | 2 | 2 | 4 | 16 |
| height | | | | | | | | | | | |
| (mm) | | | | | | | | | | | |
| Transmittance | 91.15 | 90.07 | 90.32 | 90.41 | 90.18 | 90.57 | 90.73 | 90.03 | 90.71 | 91.41 | 91.25 |
| (%) | | | | | | | | | | | |
| Separation | x | x | x | x | x | x | x | ∘ | ∘ | x | ∘ |

As shown in Table 5, the laminates according to the Examples exhibited excellent properties in terms of transparency, impact resistance, and scratch resistance, and thus could be applied to a window sheet requiring transparency and impact resistance. However, the laminate prepared in Comparative Example 1 using an adhesive composition having a glass transition temperature exceeding −10° C. had low initial adhesive strength and suffered from separation. The laminate prepared in Comparative Example 2 using an adhesive composition having a glass transition temperature below −50° C. also had good initial viscosity but suffered from separation due to low cohesion and durability. In addition, the laminate prepared in Comparative Example 3 and including the base sheet, the impact resistance of which did not accord with the Examples, had an undesirable thickness and did not absorb impact well in ball drop testing, causing occurrence of cracking. The laminate prepared in Comparative Example 4 and including a low thickness was severely curled upon lamination into the structure of FIG. 1.

(2) Details of components used in Examples 8 to 16 and Comparative Examples 5 to 9 are as follows:

(1) Base film: polyethylene terephthalate film (Thickness: 100 μm)

(2) Silsesquioxane-containing film: Silplus® J200 (Nippon Steel Chemical Group) (Thickness of: 200 μm)

(3) Coating layer 1

(B11) Fluorine-modified acrylate copolymer: TU-2180 (JSR Corp., Weight average molecular weight: 550 g/mol, Number of functional groups: 3)

(B12) Fluorine-modified acrylate monomer: TU-2157 (JSR Corp., Weight average molecular weight: 400 g/mol, Number of functional groups: 1 to 2)

(B13) Hollow silica: TU-2286 (JSR Corp., silica 50%+acryl binder 50%, Average particle size: 30 nm)

(B14) Reactive silica (Inorganic nanoparticles subjected to surface treatment with acrylate): SST650U (Average particle size: 20 nm, Ranco)

(B15) Initiator: Irgacure 184 (Ciba)

(4) Coating layer 2

(B21) UV curable resin: HX-920UV (Kyoeisha)

(B22) Polyfunctional acrylate monomer: DPHA (SK Cytec)

(B23) Hollow silica: TU-2286 (JSR Corp., silica 50%+acryl binder 50%, Average particle size: 30 nm)

(B24) Reactive silica (Inorganic nanoparticles subjected to surface treatment with acrylate): SST650U (Average particle size: 20 nm, Ranco)

(B25) Photo-polymerization initiator: Irgacure 184 (Ciba)

(B26) Silicon-modified polyacrylate: SILCLEAN 3700 (BYK)

(B27) Anti-foaming agent: BYK065 (BYK)

### Examples 8 to 12

The aforementioned components were mixed with 100 parts by weight of methylisobutylketone in amounts as listed in Table 6 (unit: parts by weight) to prepare compositions for coating layers. A silsesquioxane-containing film was stacked on a base film, followed by coating the composition and drying for 100 seconds to form a coating layer having a thickness of 100 nm. The coating layer was cured under a metal halide lamp at 250 mJ/cm², thereby preparing a laminate.

### Comparative Examples 5 to 6

Instead of the base film having the silsesquioxane-containing film stacked thereon in Example 8, a polyethylene terephthalate (PET) (thickness: 100 μm) free from the silsesquioxane-containing film was used. The aforementioned components were added in amounts as listed in Table 6 to prepare compositions for coating layers. Laminates (coating layer thickness: 100 nm) were prepared in the same manner as in Example 8.

### Examples 13 to 16

The aforementioned components were mixed with 100 parts by weight of methylisobutylketone in amounts as listed in Table 7 (unit: parts by weight) to prepare compositions for coating layers. A silsesquioxane-containing film was stacked on a base film, followed by coating the composition and drying for 100 seconds to form a coating layer having a thickness of 100 nm. The coating layer was cured under a metal halide lamp at 250 mJ/cm², thereby preparing a laminate.

### Comparative Examples 7 to 8

Laminates were prepared in the same manner as in Example 13 except for the compositions were varied as listed in Table 7.

### Comparative Example 9

A laminate was prepared in the same manner as in Example 13 except that instead of the base film having the silsesquioxane-containing film stacked thereon, a polyethylene terephthalate (PET) (thickness: 100 μm) was used.

The laminates prepared in Examples 8 to 16 and Comparative Examples 5 to 9 were evaluated as to the following properties, and results are listed in Tables 6 and 7.

Evaluation of Physical Properties

1. Water contact angle and hexadecane contact angle: These were measured to evaluate surface tension of the coating layer in the laminate. A droplet of distilled water or hexadecane was dropped on the coating layer. Then, the contact angle was determined using a contact angle tester (Phoenix 300, Modified type, Surface Electro Optics, Measurement frequency: three times/batch,) at 25° C.

2. Reflectivity: A specimen was prepared by attaching a black sheet to a base film of a laminate and heating the resultant to 80° C. in an off-line laminator. With the coating layer of the laminate placed to face a light source, reflectivity was measured at a wavelength of 550 nm (visible light region) using a UV/VIS spectrometer (Lambda 950, PERKIN ELMER). The measured reflectivity was the reflectivity of the coating layer in the window sheet.

3. Haze and transmittance: Haze and transmittance of the coating layer in the laminate were measured. With the coating layer of the laminate placed to face a light source (D65), the haze and transmittance of the coating layer were measured using a hazemeter at a wavelength band of 400 nm to 800 nm (NDH2000, Modified type, Nippon Denshoku, Measurement frequency: once/batch).

4. Pencil hardness: Pencil hardness of the coating layer in a laminate was measured. The pencil hardness was determined using a Pencil Hardness/Scratch Resistance Tester (14FW, Heidon, Measurement frequency: 5 times/batch,) with respect to the laminate. A range of pencil hardnesses capable of being measured from the Tester is 5 B to 9 H.

Contact angle after rubbing test: Under a load of 500 g, an eraser was reciprocated 250 times (40 times per minutes) on a laminate sample while methyl alcohol (99.3%) was supplied thereto. An eraser stroke was 15 mm, the methyl alcohol was added at a rate of 1 ml/50 times, and the eraser was placed to protrude a distance of 5 mm from a distal end of a jig. The eraser was used to perform rubbing test with respect to the laminate. After completion of the rubbing test, the water contact angle was determined by the same method as described above.

TABLE 6

| | | | | | | | Comparative | |
|---|---|---|---|---|---|---|---|---|
| | | Example | | | | | Example | |
| | | 8 | 9 | 10 | 11 | 12 | 5 | 6 |
| (B-1) | (B11) | 14 | 14 | — | 75 | 45 | 14 | — |
| | (B12) | 74 | 74 | 59 | 17 | 30 | 74 | 88 |
| | (B13) | 9 | — | 38 | 5 | — | 9 | 9 |
| | (B14) | — | 9 | — | — | 22 | — | — |
| | (B15) | 3 | 3 | 3 | 3 | 3 | 3 | 3 |

| | | | | | | | |
|---|---|---|---|---|---|---|---|
| Water contact angle | 91.21 | 93.14 | 90.99 | 91.05 | 107.7 | 91.21 | 82.26 |
| (°) | | | | | | | |
| Hexadecane contact | 27.68 | 33.05 | 32.54 | 33.35 | 35.22 | 27.68 | 23.55 |
| angle (°) | | | | | | | |
| Reflectivity (%) | 0.969 | 1.328 | 1.03 | 1.055 | 1.322 | 0.969 | 1.252 |
| Transmittance (%) | 92.89 | 92.24 | 92.61 | 91.95 | 92.11 | 91.26 | 91.22 |
| Haze (%) | 0.11 | 0.11 | 0.09 | 0.15 | 0.12 | 0.21 | 0.23 |
| Pencil hardness | 6H | 6H | 7H | 6H | 7H | 2H | 2H |
| Water contact angle | 81.22 | 79.25 | 80.11 | 83.22 | 95.22 | 69.48 | 62.59 |
| after rubbing test | | | | | | | |
| (°) | | | | | | | |

TABLE 7

| | | Example | | | | Comparative Example | | |
|---|---|---|---|---|---|---|---|---|
| | | 13 | 14 | 15 | 16 | 7 | 8 | 9 |
| (B-2) | (B21) | 50 | 50 | 50 | 50 | 50 | 50 | 50 |
| | (B22) | 10 | 10 | 10 | 10 | 10 | 10 | 10 |
| | (B23) | — | — | — | 40 | — | — | — |
| | (B24) | 40 | 40 | 40 | — | 40 | 40 | 40 |
| | (B25) | 1 | 1 | 1 | 1 | 1 | 1 | 1 |
| | (B26) | 1 | 1 | 1 | 1 | 1 | — | 1 |
| | (B27) | 1 | 0.5 | 0.25 | 0.25 | — | 1 | 1 |

| | | | | | | | |
|---|---|---|---|---|---|---|---|
| Water contact | 101.74 | 95.95 | 86.29 | 100.25 | 79.61 | 62.27 | 101.74 |
| angle (°) | | | | | | | |
| Hexadecane | 38.35 | 30.22 | 24.35 | 35.22 | 15.26 | 12.35 | 38.35 |
| contact angle | | | | | | | |
| (°) | | | | | | | |
| Transmittance | 91.26 | 91.23 | 91.22 | 91.42 | 91.30 | 91.33 | 91.26 |
| (%) | | | | | | | |
| Haze (%) | 0.27 | 0.22 | 0.25 | 0.15 | 0.21 | 0.26 | 0.27 |
| Pencil | 7H | 7H | 7H | 7H | 7H | 7H | 3H |
| hardness | | | | | | | |

As shown in Tables 6 and 7, the laminates according to the Examples had a high water contact angle or a high hexadecane contact angle, and thus exhibited improvement in anti-fouling and fingerprint repellent characteristics. Further, the laminates according to the Examples had high transmittance and low reflectivity, and thus could minimize reflection of external light.

By way of summation and review, instead of glass, transparent plastic materials have attracted attention in various fields. Plastic materials may be light and relatively invulnerable to impact, thereby providing a possibility of replacing glass. Thus, various studies have been conducted to improve transparency, surface hardness, durability, and heat resistance of plastic materials. With significant advances in various display apparatuses, such as LCDs, PDPs, mobile phones, projection TVs, and the like, a window sheet placed at the outermost region of such a display apparatus may be formed using a plastic material.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A laminate for a window sheet, comprising:
a base film; and
a silsesquioxane-containing film formed on at least one of upper and lower sides of the base film.

2. The laminate as claimed in claim 1, wherein the laminate has a curling height of less than about 5 mm.

3. The laminate as claimed in claim 1, wherein the laminate has a pencil hardness of about 6 H or more.

4. The laminate as claimed in claim 1, wherein the base film has a falling dart impact strength of about 5 J or more according to ASTM D4226.

5. The laminate as claimed in claim 1, wherein the base film has an impact resistance of about 35 cm or more as measured using a DuPont drop tester (500 g, pin ½″, specimen size of 100×100 mm).

6. The laminate as claimed in claim 1, wherein the base film is formed of one or more of a polystyrene, a (meth)acrylate-styrene copolymer, a polymethylmethacrylate-rubber mixture, an acrylonitrile-styrene copolymer, a polycarbonate, a polyvinyl alcohol, a polyethylene terephthalate, a polyethylene naphthalate, a polybutylene phthalate, a polypropylene, a polyethylene, a cycloolefin polymer, a cycloolefin copolymer, an acryl, a polyvinyl fluoride, a polyamide, a polyacrylate, a cellophane, a polyethersulfone, a norbornene resin, or a cyclic olefin copolymer.

7. The laminate as claimed in claim 1, wherein the silsesquioxane-containing film has a pencil hardness of about 9 H to about 10 H as determined by a pencil hardness tester based on drawing a line at a speed of 0.8 mm/sec under a load of 1 kg.

8. The laminate as claimed in claim 1, wherein the silsesquioxane-containing film has a transmittance of about 88% or more.

9. The laminate as claimed in claim 1, further comprising: an adhesive layer between the base film and the silsesquioxane-containing film, wherein the adhesive layer is formed of an adhesive composition that includes a (meth)acrylic copolymer, the (meth)acrylic copolymer being a copolymer of a mixture of one or more monomers selected from the group of a hydroxyl group-containing vinyl monomer, an alkyl group-containing vinyl monomer, a carboxylic acid group-containing vinyl monomer, and an aromatic group-containing vinyl monomer.

10. The laminate as claimed in claim 9, wherein the adhesive layer has a glass transition temperature of about −50° C. to about −10° C.

11. The laminate as claimed in claim 9, wherein the adhesive layer has a modulus of about 1×10⁴ to about 1.5×10⁶ dyn/cm².

12. The laminate as claimed in claim 1, further comprising a coating layer formed on one side of the silsesquioxane-containing film, the coating layer being formed of a composition including a fluorine-containing (meth)acrylate-based compound and inorganic nanoparticles, the fluorine-containing (meth)acrylate-based compound including one or more of a fluorine-modified (meth)acrylate copolymer or a fluorine-modified (meth)acrylate monomer.

13. The laminate as claimed in claim 12, wherein the coating layer has a water contact angle of about 80° or more or a hexadecane contact angle of about 25° or more at 25° C.

14. The laminate as claimed in claim 12, wherein the coating layer has a reflectivity of about 2% or less at a wavelength of 550 nm.

15. The laminate as claimed in claim 12, wherein:
the fluorine-containing (meth)acrylate-based compound includes the fluorine-modified (meth)acrylate copolymer and the fluorine-modified (meth)acrylate monomer, and
a weight ratio of the fluorine-modified (meth)acrylate monomer to the fluorine-modified (meth)acrylate copolymer in the composition ranges from about 0.1 to about 6.

16. The laminate as claimed in claim 12, wherein the composition includes about 40 to 95 parts by weight of the fluorine-containing (meth)acrylate-based compound and about 1 to 50 parts by weight of the inorganic nanoparticles, based on 100 parts by weight of the composition.

17. The laminate as claimed in claim 12, wherein the composition further includes one or more of a silicon-modified polyacrylate or an anti-foaming agent.

18. The laminate as claimed in claim 17, wherein the composition includes: about 35 to 95 parts by weight of the fluorine-containing (meth)acrylate-based compound and about 5 to 45 parts by weight of the inorganic nanoparticles, and, based on a total of 100 parts by weight of the fluorine-containing (meth)acrylate-based compound and the inorganic nanoparticles, about 0.1 to 10 parts by weight of an initiator, about 0.1 to 5 parts by weight of the silicon-modified polyacrylate, and about 0.01 to 5 parts by weight of the anti-foaming agent.

19. The laminate as claimed in claim 12, wherein the inorganic nanoparticles include one or more of hollow silica or reactive silica.

20. The laminate as claimed in claim 19, wherein the inorganic nanoparticles include the hollow silica, the hollow silica being subjected to surface treatment with a fluorine compound.

21. The laminate as claimed in claim 19, wherein the inorganic nanoparticles include the reactive silica, the reactive silica being subjected to surface treatment with a (meth)acrylate-based compound.

22. The laminate as claimed in claim 17, wherein the composition includes the silicon-modified polyacrylate, the silicon-modified polyacrylate including a hydroxyl group at a terminal thereof.

23. The laminate as claimed in claim 17, wherein the composition includes the silicon-modified polyacrylate, the silicon-modified polyacrylate having an acid value of about 20 to about 40 mgKOH/g in terms of solid content.

24. The laminate as claimed in claim 17, wherein the anti-foaming agent includes one or more of dimethylpolysiloxane or fluorine-modified polysiloxane.

25. A window sheet comprising the laminate as claimed in claim 1.

26. A display apparatus comprising the window sheet as claimed in claim 25.
